(19) United States
(12) Patent Application Publication
(10) Pub. No.: US 2005/0028204 A1
(43) Pub. Date: Feb. 3, 2005

(54) Electronic apparatus, screen control method and screen control program

(76) Inventors: Takashi Nakamura, Mitaka-shi (JP); Takahisa Yoneyama, Yokohama-shi (JP); Tadatsugu Kotani, Tokyo (JP); Takeo Horiguchi, Yokohama-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/819,548

(22) Filed: Apr. 6, 2004

(30) Foreign Application Priority Data
Jul. 28, 2003 (JP) 2003-281314

(51) Int. Cl. H04N 5/445; G06F 13/00; G06F 3/00; H04N 9/74; G06F 17/30; G06F 7/00; H04N 7/025

(52) U.S. Cl. 725/45; 348/563; 348/564; 348/586; 725/135; 725/32; 715/500.1; 715/501.1

(57) ABSTRACT

A multimedia recording and playback apparatus of the present invention is a multi-functional electronic apparatus which can deal with content of plural categories, such as television broadcasting data, video data, music data and photographic data, and can output image data and sound data of each content item from a television apparatus. Further, during playback of any content item, if an instruction is issued, by control of a remote controller, to display a title list of content items available at present, the multimedia recording and playback apparatus display the title list of the content items available at present, in a manner superposed on images of the content item being displayed, while image display of the content item being displayed is maintained.

### CROSS-REFERENCE TO RELATED APPLICATIONS

This application is based upon and claims the benefit of priority from the prior Japanese Patent Application No. 2003-281314, filed Jul. 28, 2003, the entire contents of which are incorporated herein by reference.

### BACKGROUND OF THE INVENTION

1. Field This invention generally relates to an electronic apparatus which has a function of playing back content items including image data, such as viewing, recording and playback of TV programs, and a screen control method and a screen control program which are applied to the apparatus.

2. General Background

With improvement in information processing technique and communication technique in recent years, a large quantity of content items in various forms are manufactured and distributed. Further, with this tendency, multi-function electronic apparatuses can be manufactured to support all the various content items alone.

Since multi-function electronic apparatuses deal with many kinds of content items, they are normally implemented with a menu-driven mechanism for showing information of content items separate from the content item itself.

For instance, if any content item is to be used in the multi-function electronic apparatuses, the user selects the category of content to be used, by a menu of a higher level. Then, in a menu of a lower level, the user selects a desired title from titles (title list) of content items in the category, and thereby starts use of the selected content item. Specifically, it is premised that the title list of the content items are displayed before use of any content item, that is, in the state where no content items are in use. This premise is not limited to multi-function apparatuses, but is applicable to the case of displaying a title list in single-function electronic apparatuses.

However, there are many cases where the user may want to search for content items during viewing or listening to another content item. In such cases, in the conventional art, the user has to exit the content item and display the title list. Thereafter, if the user finds another desirable content item, the user starts use of the desirable content item. In the meantime, if the user does not find it, the user has to restart the content item exited before. In the conventional art, it is impossible to even refer to the title list of content items in the same category while using a content item, let alone to refer to the title list of content items of another category while using a content item of one category.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is an exemplary diagram illustrating an operating environment of a multimedia recording and playback apparatus according to an embodiment of the present invention;

FIG. 2 is an exemplary diagram illustrating an apparatus structure of the multimedia recording and playback apparatus of the embodiment;

FIGS. 3A and 3B are first exemplary diagrams illustrating changes in screen display of the multimedia recording and playback apparatus of the embodiment;

FIGS. 4A and 4B are second exemplary diagrams illustrating changes in screen display of the multimedia recording and playback apparatus of the embodiment;

FIG. 5 is an exemplary diagram illustrating an appearance of a remote controller used for remote control of the multimedia recording and playback apparatus of the embodiment;

FIG. 6 is an exemplary diagram illustrating an example of display of a title list by the multimedia recording and playback apparatus of the embodiment;

FIG. 7 is an exemplary diagram illustrating an example of display of detailed information of a content item by the multimedia recording and playback apparatus of the embodiment; and

FIG. 8 is an exemplary flow chart illustrating an operation procedure of screen control in the multimedia recording and playback apparatus of the embodiment.

### DETAILED DESCRIPTION

Exemplary embodiments of the invention relate to concurrent illustration of content items and a listing of content items presently available for viewing and/or listening. The details of various embodiments of the invention are explained below with reference to the drawings.

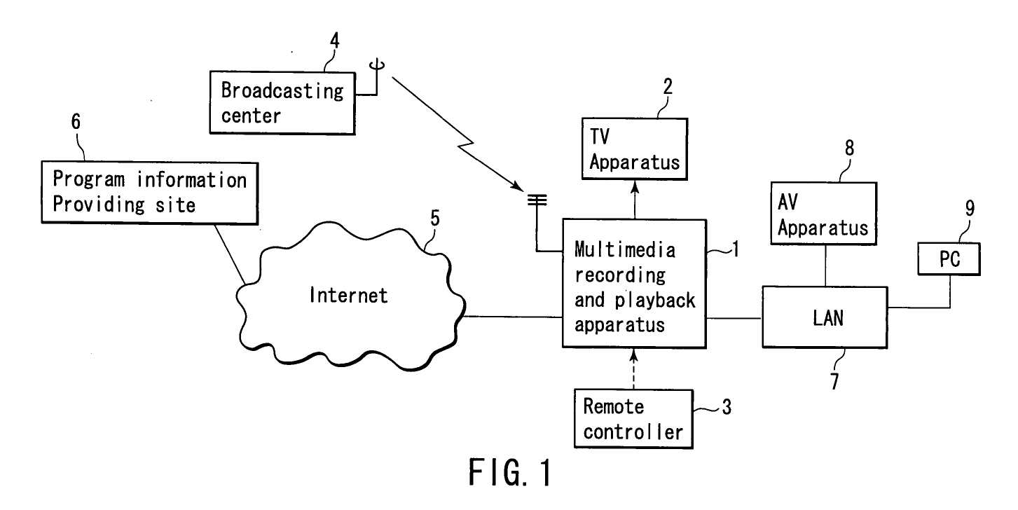

FIG. 1 is an exemplary diagram illustrating an operating environment of a multimedia recording and playback apparatus according to an embodiment of the present invention.

A multimedia recording and playback apparatus 1 is a multifunction electronic apparatus which can support multiple categories of content items, such as television broadcasting data, video data, music data, photographic data or any combination thereof. The apparatus 1 can output image data and sound data of each content item via a television (TV) apparatus 2. Further, the multimedia recording and playback apparatus 1 can be remotely controlled by using a remote controller 3.

The multimedia recording and playback apparatus 1 has a TV function which receives television broad-casting broadcasted from a broadcasting center 4 over a communication link (e.g., cable, optical fiber, air, wire, or any combination thereof), and displays it on the TV apparatus 2. As an additional function of the TV function, the apparatus 1 has a function of obtaining data of a TV program list provided by a program information providing site 6 through the Internet 5. The TV program list data includes various information, such as broadcasting schedule (program titles and broadcasting time) of programs by the broadcasting center 4, thumbnail images obtained by cutting out typical scenes of the programs, texts showing explanation of the content items and the cast thereof, and identifiers of genres thereof.

Further, the multimedia recording and playback apparatus 1 has a video function of recording the received television broadcasts. As a main function of the video function, the apparatus 1 has a recording reservation function using the TV program list data obtained from the program information providing site 6. If a program is recorded, the multimedia recording and playback apparatus 1 records information of the program included in the TV program list data, as additional information of the recorded image. The video function and the television function can be simultaneously operated. For example, a television broadcast of channel B can be recorded while the user is viewing a television broadcast of channel A. Specifically, the multimedia recording and playback apparatus 1 is a so-called multi-tuner electronic apparatus.

The multimedia recording and playback apparatus 1 also has a server function, and can be connected with an audiovisual (AV) apparatus 8 and a personal computer (PC) 9 through a LAN (local area network) 7 constructed home. The server function is used for collectively storing music data transmitted from the AV apparatus 8 and photographic data transmitted from the PC 9. The stored music data or photographic data are outputted from the TV apparatus 2 in response to a playback instruction from the remote controller 3.

Besides using the LAN 7, music data and photographic data can be captured in a standalone environment by using peripheral devices mounted on the multimedia recording and playback apparatus 1. Further, an instruction to playback the stored data is received also from the AV apparatus 8 and the PC 9 via the LAN 7, besides an instruction from the remote controller 3. In such a case, the multimedia recording and playback apparatus 1 transmits the required data to the AV apparatus 8 or the PC 9 which requires the data, via the LAN 7. An instruction concerning the TV function and the video function can also be received via the LAN 7. Therefore, the user can view a TV broadcast, perform a record reservation or view a recorded program, by using the PC 9, in another room different from the room in which the multimedia recording and playback apparatus 1 is located.

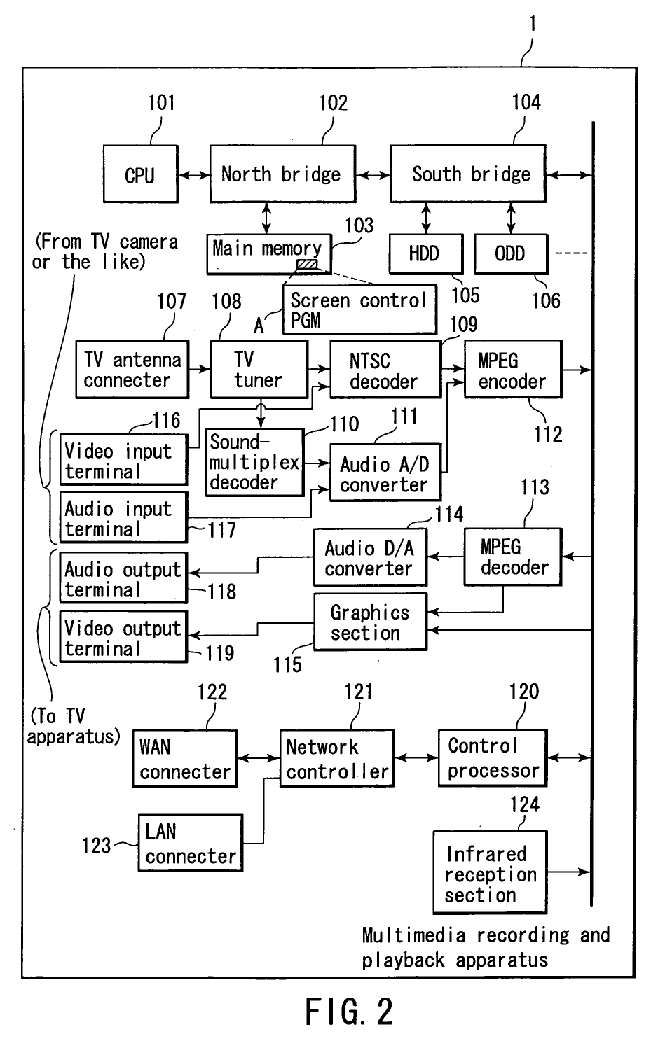

FIG. 2 is an exemplary diagram illustrating an apparatus structure of the multimedia recording and playback apparatus 1.

A CPU 101, namely any circuitry that processes data such as a general microprocessor, an application specific integrated circuit, a digital signal processor, a micro-controller, or some type of programmable logic device, manages control of the whole multimedia recording and playback apparatus 1. In addition, the CPU 101 executes various programs stored in a main memory 103, and access to which is controlled by a north bridge 102. The main memory 103 stores a screen control program A which bears a part of a user interface of the multimedia recording and playback apparatus 1. The screen control program A includes one or more subprograms for screen control, which is the feature of the multimedia recording and playback apparatus 1. The operation principle of the program is described later.

The north bridge 102 is further in communication with a south bridge 104. The CPU 101 and the main memory 103 are connected to a system bus via the north bridge 102 and the south bridge 104. Further, the south bridge 104 controls various peripheral devices, such as a hard disk drive (HDD) 105 and/or an optical disk drive (ODD) 106. The HDD 105 and/or the ODD 106 store the content items, namely the TV program list data, video data, music data, photographic data or any combination thereof.

According to one embodiment of the invention, a TV antenna is connected to the multimedia recording and playback apparatus 1, with a TV antenna connector 107 interposed therebetween. A TV broadcasting signal inputted via the TV antenna connector 107 is transmitted to a TV tuner 108. Of course, according to another embodiment of the invention, the TV antenna and TV antenna connector 107 may be substituted for a cable TV connector for receipt of content items transmitted over a cable.

For both of these embodiments, the TV tuner 108 receives TV broadcast program data of a channel, viewing of which has been requested from the remote controller 3 or the PC 9 via the LAN 7. Based on the viewing request, the TV tuner 108 performs reception of the TV broadcasting signal and channel selection.

A video signal of the TV broadcast program data of a channel, which has been received by the TV tuner 108, is transmitted to an NTSC decoder 109 and converted into digital data. Further, an audio signal of the data is transmitted from a sound-multiplex decoder 110 to an audio A/D converter 111, and converted into a digital signal. The sound-multiplex decoder 110 interposed between the TV tuner 108 and the audio A/D converter 111 performs, according to necessity, demodulation of a sound-multiplexed signal superposed on the TV broadcast program data, such as a second sound channel.

The NTSC decoder 109 is also connected to a video input terminal 116. Thus, it is possible to input a video signal from an external video apparatus, such as a DVD player. Further, the audio A/D converter 111 is also connected to an audio input terminal 117. It is thus possible to input an audio signal from an external audio (video) apparatus.

An encoder 112 compresses and encodes the input video data and audio data. According to one embodiment of the invention, the encoder 112 is deployed to perform Moving Pictures Experts Group (MPEG) compression and encoding. For instance, according to the embodiment described, MPEG-2 is used for this compression and encoding by the encoder 112. Of course, the encoder 112 may use other compression and encoding techniques besides MPEG. For this description, however, the encoder 112 will be described as an “MPEG” encoder.

The TV broadcast program data received by the TV tuner 108 is compressed and encoded by the MPEG encoder 112 and converted into a stream of data (e.g., an MPEG stream). The compressed and encoded TV broadcast program data is transmitted to a decoder 113 (e.g., MPEG decoder) if viewed by the TV apparatus 2, to a control processor 120 described later if viewed by the PC 9 through the LAN 7, and to the HDD 105 if recorded.

For instance, when deployed as an MPEG decoder, the MPEG decoder 113 decodes the TV broadcast program data compressed and encoded in MPEG-2. For example, if the compressed and encoded TV broadcast program data recorded in the HDD 105 is viewed by the TV apparatus 2, the compressed and encoded TV broadcast program data read from the HDD 105 is transmitted to the MPEG decoder 113, and decoded therein.

The video data decoded by the MPEG decoder 113 passes through a graphics section 115, and is transmitted to the TV apparatus 2 through a video output terminal 119. The audio data decoded by the MPEG decoder 113 is converted into an analog signal in an audio D/A converter 114, and transmitted to the TV apparatus 2 through an audio output terminal 118. The graphics section 115 can superpose image data prepared by the CPU 101 on the video data decoded by the MPEG decoder 113. Further, the graphics section 115 can set transparency of the image data to be superposed, in response to an instruction from the CPU 101. Examples of the graphics section 115 include, but is not limited or restricted to graphics circuitry.

Specifically, when image synthesis is performed to superpose the image data prepared by the CPU 101 on the video data decoded by the MPEG decoder 113, the transparency of the image data is controlled. This allows an image to be prepared, in which the decoded video data can be viewed through the image data.

A WAN (Wide Area Network) connector 122 is a terminal used for data transmission and reception with the Internet 5. A LAN connector 123 is a terminal used for data transmission and reception with the LAN 7. A network controller 121 is a network control device, which controls the data transmission and reception with the Internet 5 via the WAN connector 122, and those with the LAN 7 via the LAN connector 123. The control processor 120 controls the network controller 121 in response to an instruction from the CPU 101.

An infrared reception section 124 receives an infrared signal transmitted from the remote controller 3, and communicates contents of an operation indicated by the infrared signal to the CPU 101. More specifically, when the infrared signal is received, the infrared reception section 124 stores operation information of the signal in its built-in register (not shown), and generates an interrupt to the CPU 101. When the CPU 101 requests reference to the built-in register in response to the interrupt, the infrared reception section 124 outputs the operation information to the system bus.

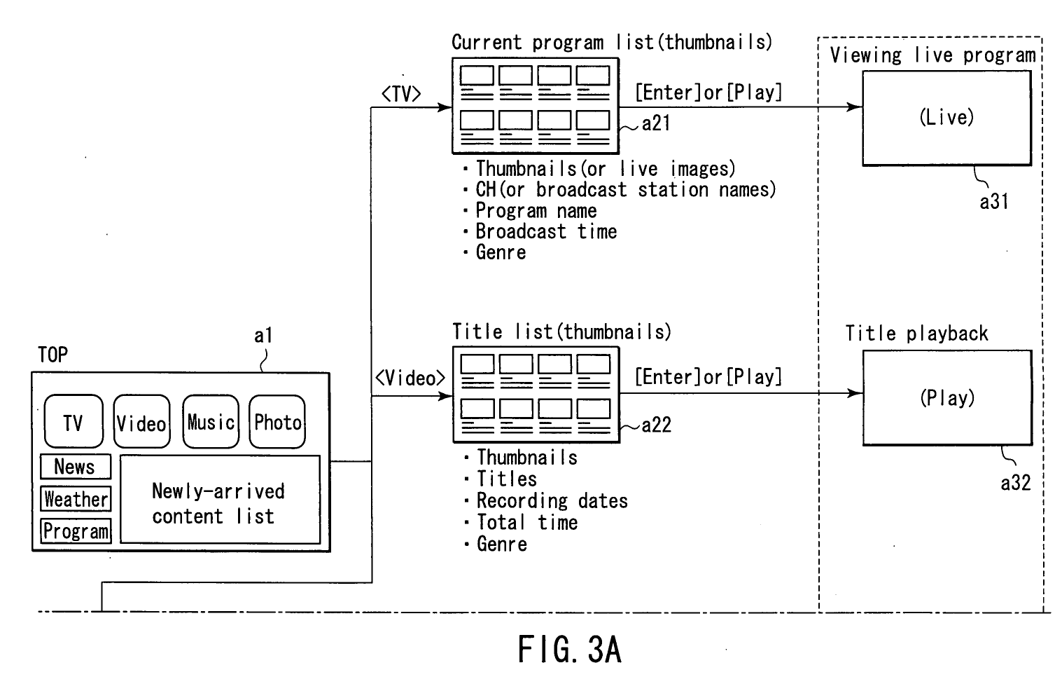

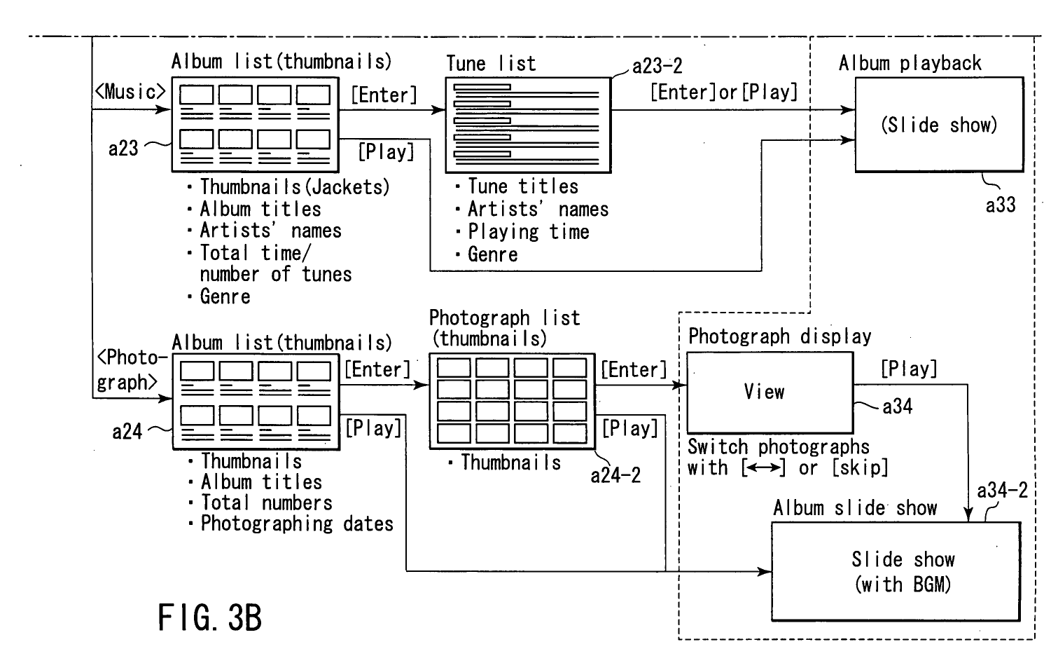

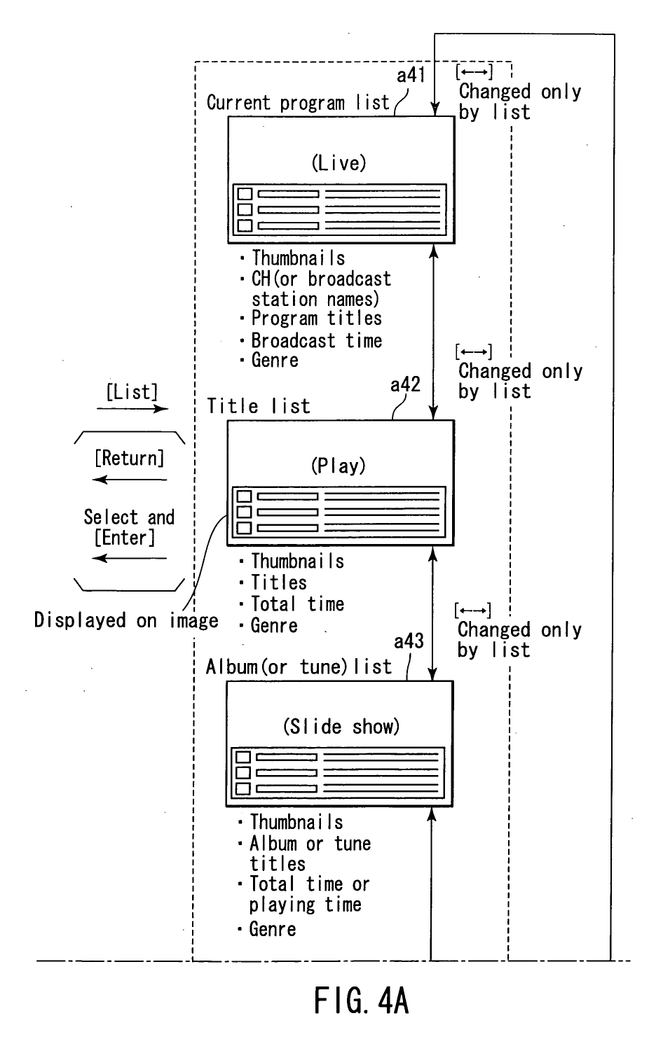

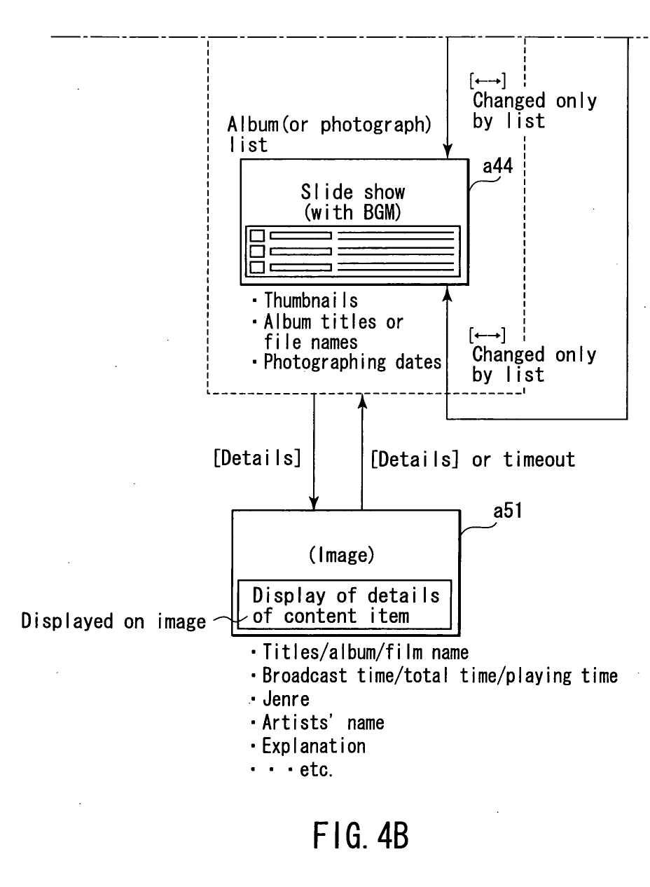

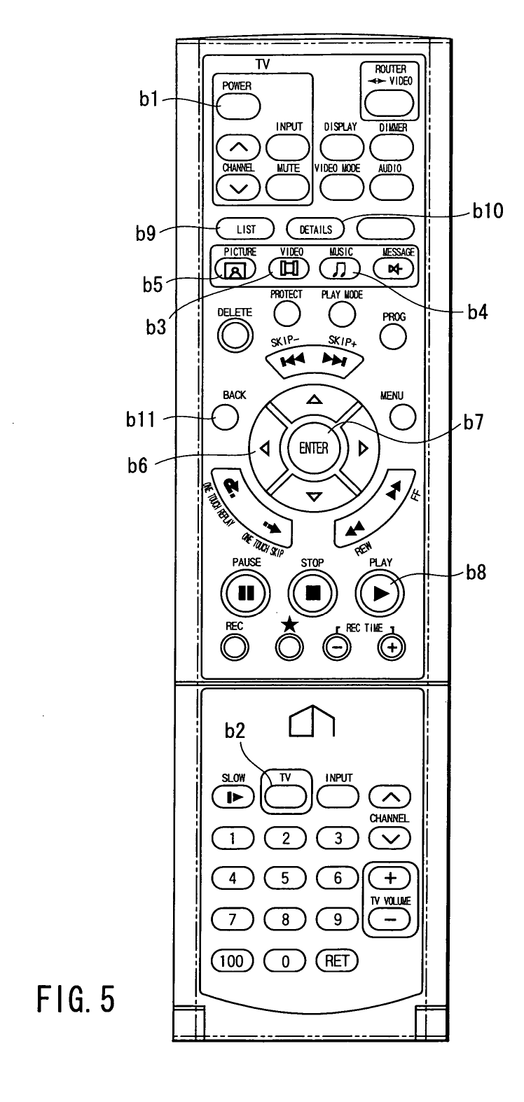

Next, with reference to FIGS. 3A to 5, explained is a process of screen control performed by the multimedia recording and playback apparatus 1. FIGS. 3A and 3B and 4A and 4B are exemplary diagrams illustrating changes in screen display in the multimedia recording and playback apparatus 1. FIG. 5 is an exemplary diagram illustrating an appearance of the remote controller 3 used for remote control of the multimedia recording and playback apparatus 1.

As described above, the multimedia recording and playback apparatus 1 is a multifunction electronic apparatus, which can deal with multiple kinds of content such as, for example, television broadcast data, video data, music data, photographic data or any combination thereof. Therefore, in response to an instruction to turn on the power of the apparatus 1, the screen control program A produces a screen display al, as an initial screen display, for selecting a category of content to be used.

The instruction to turn on the power is made by pressing a button b1 of the remote controller 3 shown in FIG. 5. Further, the category of a content item to be used is selected by pressing any one of buttons b2 to b5. When one of these buttons is pressed, the screen control program A changes the screen display al being the initial screen to one of screen displays a21 to a24 of the respective categories.

Each of the screen displays a21-a24 shows a list of content items which are available in the category at present. These lists a21-a24 include not only titles but also various information, such as any combination of the following: thumbnail images, channel (CH) numbers or broadcast station names, program names, broadcast time, genre, titles, recording dates, total play time, album title(s), artists' names, number of songs, number of pictures, or photographing date. Thus, the user can understand the details of each content item with ease by viewing lists a21-a24. The user, who has selected the list a21, . . . or a24, selects a desired content item by operating a button b6 which can change a selected item among the items displayed on the screen in the four directions (up, down, right, and left).

Then, the user issues an instruction to start use of the desired content item by pressing a button b7 or button b8. In the meantime, the screen control program A, which has received the operation, changes screen displays from the screen displays a21-a24 to respective corresponding screen displays a31 to a34-2 which displays an image of the selected content item. As described above, the user can select and use any content item among the categories of the television video data, video data, music data, photographic data or the like.

Next, considered is the case where the user thinks of searching another desirable content item, during use of a content item on the screen with any of the screen displays a31 to a34-2. In such a case, the multimedia recording and playback apparatus 1 can display a title list of content items available at present in the selected category, by pressing down a button b9 of the remote controller 3, while maintaining the image display of the content item in use.

If the button b9 is pressed during viewing of a TV program on the screen in the state of the screen display a31, as shown in a screen display a41 in FIG. 4A, the screen control program A provides display of a title list of TV programs on the air at present, superposed on the images of the TV program being viewed. This image synthesis is performed by the graphics section 115. In this process, the screen control program A performs control such that the image of the TV program can be viewed through the title list, by setting the transparency of the title list to be superposed to a proper value.

In the same manner, if the button b9 is pressed during viewing of a recorded program on the screen in the state of the screen display a32, as shown in a screen display a42 in FIG. 4A, a title list of recorded programs which can be played back at present is displayed. The same is performed in the case where the button b9 is pressed during playback of music data and photographic data (screen displays a43 and a44).

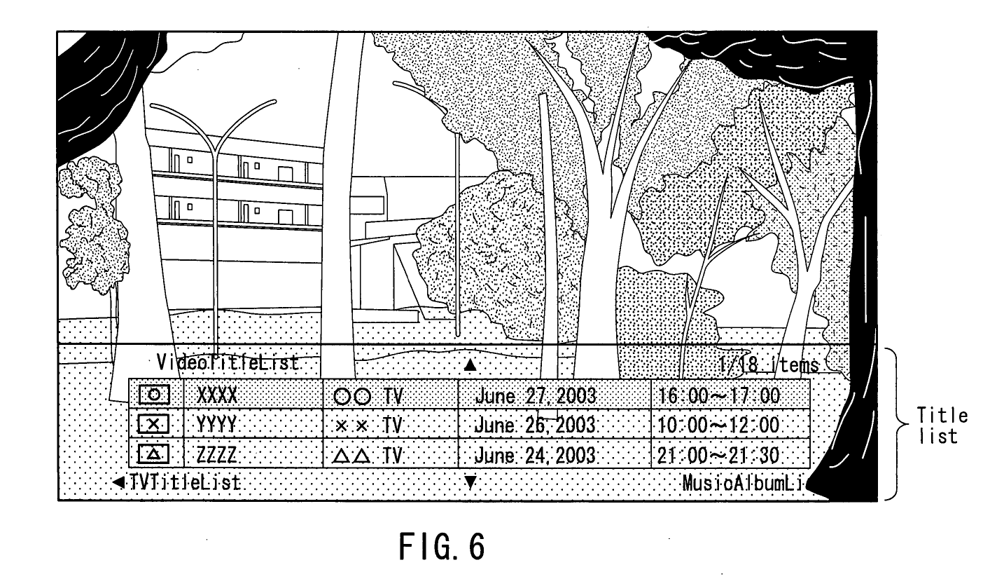

FIG. 6 is an exemplary diagram illustrating an example of the screen display in the case where the button b9 of the remote controller 3 is pressed during playback of a recorded program. As shown in FIG. 6, the user can view a title list of recorded programs together, while keeping viewing the image display of the recoded program being played back. In response to an instruction to move it in the vertical direction by the button b6, the screen control program A scrolls the title list, and thereby realizes display of many titles with a limited display space. Further, when the button b7 or button b8 is pressed in the state where one of the titles is selected by operation of the button b6, the screen control program A stops image display of the recorded program being played back, and starts playback, that is, image display, of the selected recorded program. When image display of the selected recorded program is started, the screen control program A removes the title list from the screen display. In the meantime, if the user finds no particular recorded program which the user wants to view even by replacing the recorded program being played back with it, the user can remove the title list without changing the programs, by pressing a button b11.

The title list displayed in this process also shows various information, such as thumbnail images, channel (CH) numbers or broadcast station names, or even broadcast times in addition to titles. Although it is a so-called brief version in comparison with the title list shown in each of the screen displays a21 to a24, the user can easily visually understand the details of each content item, by referring to the list.

Further, it is possible to display a title list of content items in a category different from that of the content item in use. For example, if an instruction is issued to move selection among the items on the screen to the left by pressing the button b6 while the title list of the recorded programs is displayed in playback of a recorded program as shown in FIG. 6, the screen control program A replaces the title list of the recorded programs with the title list of TV programs on the air at present. During this operation, the screen control program A maintains display of the images of the recorded program being played back. Specifically, the user can see the title list of TV programs on the air at present simultaneously with viewing the recorded program being played back. Further, if the button b7 or the button b8 is pressed in the state where any one title is selected by operation of the button b6, the screen control program A stops the image display of the recorded program being played back, and starts image display of the selected TV program.

As described above, in the multimedia recording and playback apparatus 1, the user can see a list of content items available at that time while viewing images of a content item. If the user finds a desired content item in the list, the user can easily switch the content item in use to the desired content item.

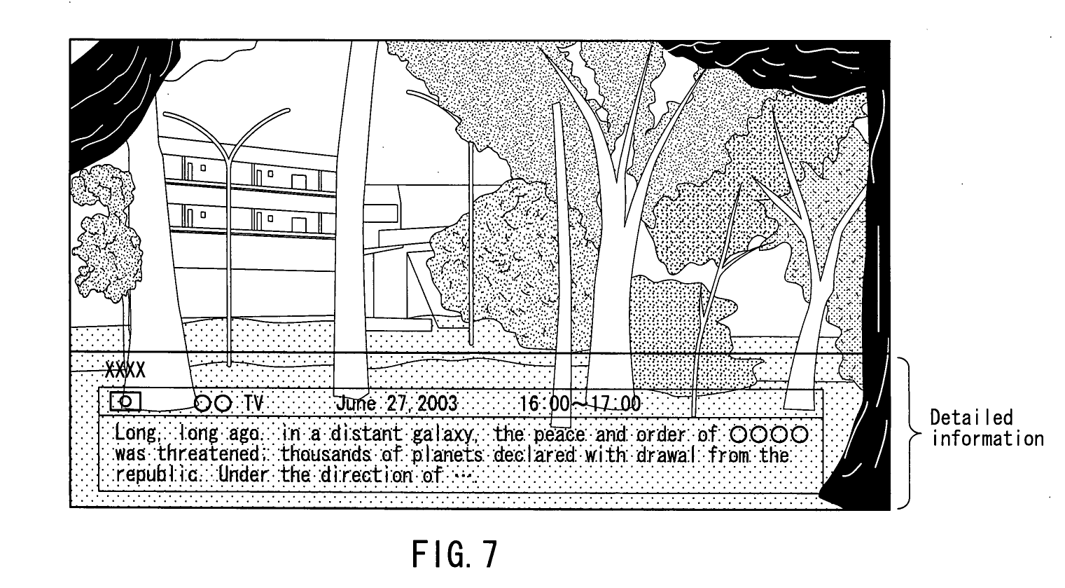

Further, during display of the title list, when the button b10 is pressed down in the state where any one title is selected, the screen control program A replaces the title list with detailed information of the selected content item, which is superposed on the images of the content item in use (FIGS. 4A, 4B: screen displays a41 to a44->screen display a51). For example, during display of the title list of recorded programs shown in FIG. 6, if the button b10 is pressed in the state where the content of title “XXXX” displayed on the uppermost line is selected, the user can also see detailed information of the content item “XXXX” while viewing the image display of the recorded program in playback, as shown in FIG. 7.

The display of the detailed information is continued, until the button b11 is pressed or a predetermined time is passed (timeout). When the button b11 is pressed or a timeout occurs, the screen control program A returns the screen display to the display of the previous title list.

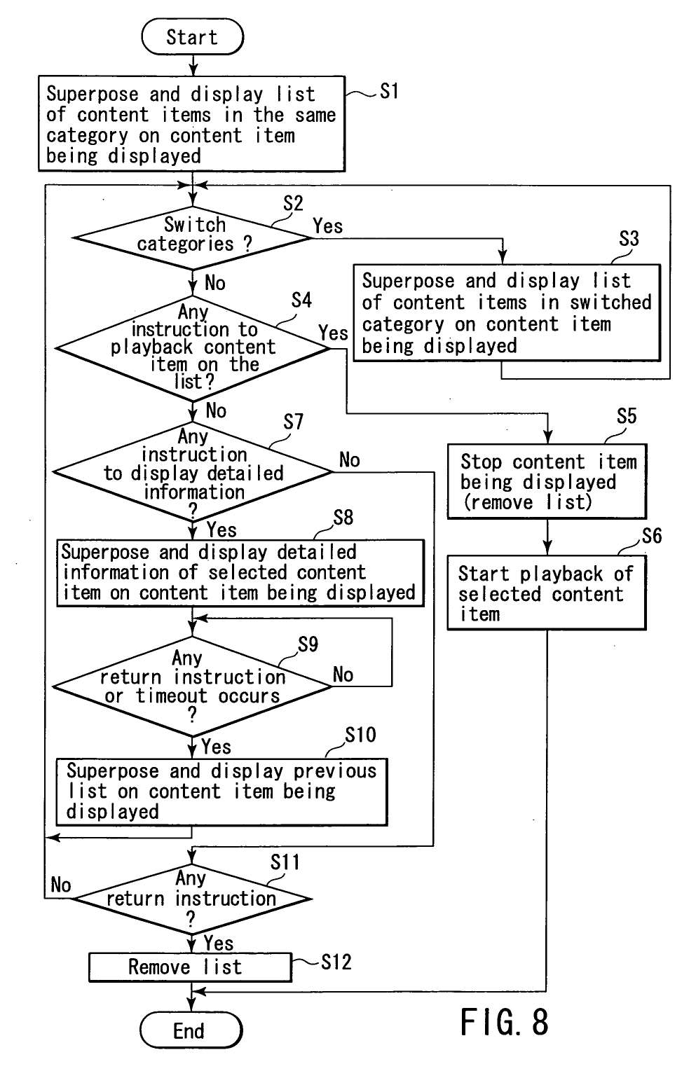

Next, explained is an operation process in the case where display of a title list is instructed during use of any content item, with reference to the flow chart of FIG. 8.

For example, display of a title list is instructed during playback of a recorded item, first the screen control program A provides display of a title list of recorded programs in the same category, in a manner of being superposed on the images of the recorded program being played back (block S1). After display of the title list, if the apparatus is instructed to change the categories to be displayed (YES of block S2), the screen control program A displays a list of content items in a category to which the current category is switched. The list is displayed in a manner of being superposed on the images of the recorded program being played back (block S3).

Then, if an instruction is issued to use any one content item of a title among the titles in the title list displayed in a manner of being superposed on the images of the recorded program in playback (YES of block S4), the screen control program A automatically stops use of the content item being played back without user assistance (block S5), and starts use of the newly-selected content item (block S6). The content item before change and the content item after change may belong to the same category or different categories. In switching the content items, the screen control program A removes the title list from the screen display.

Further, when an instruction is issued to display detailed information of a content item of one of the titles in the title list displayed on the images of the recorded program being played back (YES of block S7), the screen control program A displays detailed information of the selected content item on the images of the recorded program being played back, instead of the title list (block S8). After display of the detailed information, the screen control program A waits for an instruction to return the screen display to the display list or occurrence of a timeout (block S9). If either of them occurs (YES of block S9), the screen control program A displays the title list previously displayed in the manner of being superposed on the images of the recording program in playback (block S10).

If a return instruction is issued without issuing an instruction to use a content item of a title in the displayed title list (YES of block S11), the screen control program A removes the title list from the display (block S12).

As described above, according to the multimedia recording and playback apparatus 1 of the present invention, the user can also view a title list of the content items available at present, while keeping viewing the image display of the content item in use, regardless of whether their categories are the same or not. If necessary, the user can view detailed information of each content item in the list. Further, if the user finds a content item of more interest to the user than the content item in use, the user can easily switch the content items by operation on the screen, regardless of whether the categories of the content items are the same or not. This can remarkably improve the ease-of-use of the apparatus.

In the above embodiment, explained is an example in which detailed information of TV programs is obtained from the program information providing site 6 via the Internet 5. However, the present invention is not limited to it. For example, if the detailed information is included in a television broadcast signal transmitted from the broadcasting center 4, the detailed information can be obtained therefrom.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus comprising:
means for issuing an instruction to display a list of available content items; and
control means for superposing and displaying the list on an image of a content item being played back, while playback of the content item is maintained without interruption, if the instruction to display the list is issued during playback of the content item.

2. The electronic apparatus according to claim 1, wherein the control means executes and controls image synthesis, such that an image portion of the content item being played back, on which the list is superposed, is viewed through a portion displaying the list.

3. The electronic apparatus according to claim 1, wherein the control means displays a list of content items of a category different from that of the content item being played back.

4. The electronic apparatus according to claim 1 further comprising:
means for issuing an instruction to switch categories of content items of the list to be displayed, causing the control means to switch the list of the content items superposed and displayed on the image of the content item being played back to a list of content items of a newly-instructed category, if the instruction to switch categories is issued.

5. The electronic apparatus according to claim 1, wherein the content item is video data.

6. The electronic apparatus according to claim 1, wherein the content item is a television broadcast.

7. A method comprising:
receiving an instruction to display a first list of available content items; and
superposing and displaying the first list on an image of a content item being played back, while the playback of the content item is maintained without interruption, if the instruction to display the first list is issued during playback of the content item.

8. The method according to claim 7, wherein the displaying of the first list includes performance of image synthesis, where an image portion of the content item being played back, on which the first list is superposed, is viewed through a portion displaying the first list.

9. The method according to claim 7, wherein displaying of the first list of available content items includes content items of a category different from that of the content item being played back.

10. The method according to claim 9, further comprising:
receiving an instruction to switch categories of content items of the first list to be displayed; and
switching the first list of the available content items superposed and displayed on the image of the content item being played back to a second list of available content items excluding the newly-selected content item, if the instruction to switch categories is issued.

11. The method according to claim 7, further comprising:
receiving an instruction to start playback of the newly-selected content item; and
stopping playback of the content item without user assistance if playback of the newly-selected content item on the first list is instructed.

12. The method according to claim 7, further comprising:
receiving an instruction to select one of the available content items on the first list; and
superposing and displaying a detailed information item of the selected content item on the image of the content item being played back, while image display of the content item being displayed is maintained without interruption, if display of the detailed information item is instructed.

13. A screen control program executed by a processor to playback a content item including image data, the screen control program comprising:
a first subprogram to issue an instruction to display a list of available content items; and
a second subprogram to superpose and display the list on an image of a content item being played back, while playback of the content item is maintained without interruption, if the instruction to display the list is issued during playback of the content item.

14. The screen control program according to claim 13 further comprises a subprogram to execute and control image synthesis such that an image portion of the content item being displayed, on which the list is superposed, can be viewed through a portion displaying the list.

15. An apparatus comprising:
a bus;
a processor coupled to the bus, the processor to execute a screen control program to generate image data, the image data being one of a plurality of different display screens; and
a graphics circuit coupled to the bus and the decoder, the graphics circuit to superpose the image data prepared by the processor onto the input video data and to set transparency of the image data to be superposed.

16. The apparatus according to claim 15 further comprising:
an encoder coupled to the bus, the encoder to compress and encode input video data; and
a decoder coupled to the bus, the decoder to decode and decompress the input video data after being compressed and encoded by the encoder.

17. The apparatus according to claim 16 further comprising a video output terminal coupled to the graphics circuit to provide the video input data and the superposed image data to a TV apparatus.

18. The apparatus according to claim 16 further comprising:
an audio digital-to-analog converter coupled to the decoder; and
an audio output terminal coupled to the audio digital-to-analog converter.

19. The apparatus according to claim 16 further comprising a disk drive coupled to the bus, the disk drive to store the input video data.

20. The apparatus according to claim 16 further comprising:
a network connector;
a network controller coupled to the network connector, the network controller to control data transmission and reception of input video data in a compressed and encoded format; and
a control processor coupled to the bus and the network controller.

21. The apparatus according to claim 20, wherein the network connector is a Wide Area Network connector.
